(19) United States
(12) Patent Application Publication
(10) Pub. No.: US 2025/0081054 A1
(43) Pub. Date: Mar. 6, 2025

(54) ASYMMETRIC COMMUNICATION SYSTEM WITH NETWORK AGGREGATION FOR OPTIMIZED SITUATIONAL AWARENESS

(71) Applicant: SA3, LLC, Hillsborough, NC (US)

(72) Inventors: Gerard James Hayes, Wake Forest, NC (US); Ramanathan Asokan, Cary, NC (US); Koichiro Takamizawa, Silver Spring, MD (US); James E. Ladd, JR., Hillsborough, NC (US); Elbert Stanford Eskridge, JR., Chapel Hill, NC (US)

(21) Appl. No.: 18/819,895

(22) Filed: Aug. 29, 2024

Related U.S. Application Data
(60) Provisional application No. 63/536,250, filed on Sep. 1, 2023.

(51) Int. Cl. H04W 36/00; H04W 36/30; H04W 36/32; H04W 84/06

(52) U.S. Cl. CPC H04W 36/008355; H04W 36/304; H04W 36/322; H04W 84/06

(57) ABSTRACT

A method of conducting a handover of user equipment (UE) in an asymmetrical communication super network may include receiving an indication of a need to handover from the UE, determining whether the indication corresponds to an uplink handover or a downlink handover, responsive to determining that the indication corresponds to the downlink handover, executing a downlink handover routine, and responsive to determining that the indication corresponds to the uplink handover, executing an uplink handover routine.

### TECHNICAL FIELD

Example embodiments generally relate to wireless communications and, more particularly, relate to providing an asymmetric communication system with robust security, reliability and capability for enhanced situational awareness and response.

### BACKGROUND

There are many thousands of remote facilities or areas within the United States that are important either as critical infrastructure or as sensitive assets. Providing security for these facilities, while important, has largely been overlooked due to the fact that, in many cases, the remoteness of the facilities may provide some level of security by itself, and also due to the fact that providing security in these areas would likely be prohibitively expensive. Attacks on power grid substations in late 2022 and early 2023 prompted a reconsideration of the priorities and possibilities associated with securing these facilities.

To the extent remote monitoring of facilities and/or initiation of various response measures triggered by such monitoring are performed at all, regardless of location, it is critical that the communications involved should be secure. Accordingly, example embodiments are aimed at providing a highly secure, and also highly capable, communications network that may excel in the environment noted above.

### BRIEF SUMMARY OF SOME EXAMPLES

Some example embodiments may provide a communication structure capable of providing services to remote, and even unattended facilities or areas in a highly secure context.

In one example embodiment, an asymmetric communication system may be provided. The system may include a downlink transmitter configured to transmit a waveform defining a downlink, a user equipment (UE) configured to receive transmission of the downlink from the downlink transmitter, an uplink base station operably coupled to the UE for uplink transmission from the UE via a different communication protocol than the downlink transmitter, an IP-based backhaul network operably coupled to the uplink base station, and a super network operations center (SNOC) operably coupled to the uplink base station and the downlink transmitter to provide communication services to the UE via the uplink and the downlink. The SNOC may be configured to select the uplink base station from among a plurality of candidate base stations associated with different networks capable of communication with the UE.

In another example embodiment, a method of conducting a handover of user equipment (UE) in an asymmetrical communication super network may be provided. The method may include receiving an indication of a need to handover from the UE, determining whether the indication corresponds to an uplink handover or a downlink handover, responsive to determining that the indication corresponds to the downlink handover, executing a downlink handover routine, and responsive to determining that the indication corresponds to the uplink handover, executing an uplink handover routine.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A illustrates a block diagram of a network architecture for providing services to devices in remote areas using a broadcast transmitter for downlink in accordance with an example embodiment;

FIG. 1B illustrates a block diagram of an alternative network architecture for providing services where the transmitter for downlink is not necessarily a broadcast transmitter in accordance with an example embodiment;

FIG. 2 illustrates a schematic diagram of a system for providing monitoring services to a monitored facility in accordance with an example embodiment;

FIG. 3 illustrates a block diagram of an example of user equipment that may be employed in accordance with an example embodiment;

FIG. 4 illustrates a block diagram of a super network operations controller (SNOC) that may be employed in accordance with an example embodiment;

FIG. 5 illustrates a flow diagram of a method of conducting a handover in an asymmetric communication super network in accordance with an example embodiment;

FIG. 6 illustrates a diagram of a remote facility employing passive radar in accordance with an example embodiment; and

FIG. 7 illustrates a control flow diagram showing operations associated with triggering a response based on passive radar in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal and regulatory requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As used in herein, the term “module” is intended to include a computer-related entity, such as but not limited to hardware, firmware, or a combination of hardware and software (i.e., hardware being configured in a particular way by software being executed thereon). For example, a module may be, but is not limited to being, a process running on a processor, a processor (or processors), an object, an executable, a thread of execution, and/or a computer. By way of example, both an application running on a computing device and/or the computing device can be a module. One or more modules can reside within a process and/or thread of execution and a module may be localized on one computer and/or distributed between two or more computers. In addition, these components can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments described herein provide a system, architectures and/or methods for improved real time services provision to user equipment (UE) via an asymmetric communications paradigm. In this regard, some example embodiments may provide a system that enables monitoring of facilities or areas that may be remote and further enables various responses to be triggered based on the monitoring using highly secured communications. The downlink to the UE may be provided by a complex broadcast waveform such as, for example, ATSC 3.0, various 5G signals such as, but not limited to, multimedia broadcast and multicast services (MBMS) and enhanced MBMS (eMBMS), or other multicast transmission signals. The complex broadcast waveform may provide a long range and strong signal with video channels capable of providing high resolution and high bandwidth at high data rates. Thus, large amounts of detailed content or instructions may be useful in providing instructions to the UE (or another UE) with respect to the performance of various tasks or functions. Moreover, security information may also be shared. Notably, although the downlink may be provided via a complex broadcast waveform, which may provide accurate timing signals that enhance capabilities of the system, other downlink options are also possible. For example, another broadcast option for the downlink may include Bluetooth Low Energy (BLE) transmissions, and it may also be possible to use bi-directional links for the downlink as well.

Meanwhile, the UE may be instructed with respect to which of various possible uplink options that may exist to use. The uplink options may include cellular networks, satellite networks, various public or private communication networks or virtually any network that is connected (or connectable) to an internet protocol (IP)-based backhaul. In some cases, the UE may employ software defined radio (SDR) to enable flexible or agile configuration of the UE for communication with the networks that are available for downlink support.

As will be seen below, the capabilities of the system may be managed by a network operations center (NOC) controller, which may reside in the IP-based backhaul architecture. The NOC controller may employ software defined network (SDN) control and capability to effectively not simply act as a NOC for a single network, but to instead as a super NOC (SNOC) by managing the interoperability of multiple distinct networks in connection with the formation of asymmetric communication links. The collection of distinct networks that can be managed by the SNOC may form a super network or network of networks. Among the capabilities of the system may be various activities associated with monitoring or surveilling a particular area using secure network based on the asymmetric communication links, paging of response assets (e.g., first responders, security personnel or the like), providing instructions for coordination of response or for controlling specific assets, robust environmental information gathering, triggering various functions or tasks to be performed, and/or the like.

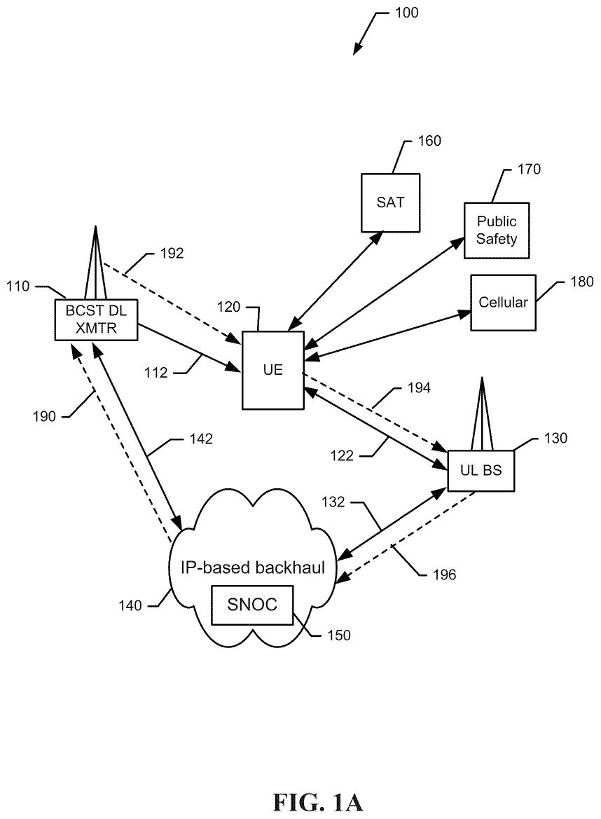

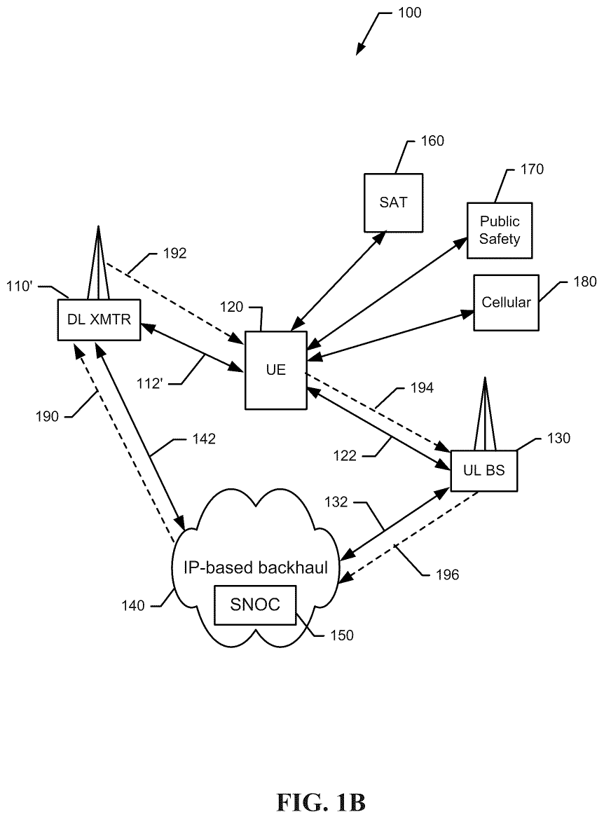

In this regard, FIG. 1A illustrates a block diagram of a network architecture of a communication system 100 for providing services to devices in remote areas in accordance with an example embodiment. The system 100 of FIG. 1A employs asymmetric communications, which generally means that the data speed or quantity of the uplink and downlink are different. However, the asymmetry of the system 100 is further exemplified by the fact that it involves transmitters and receivers that employ entirely different communication protocols (e.g., cellular protocols, private network protocols, public safety network protocols, internet of things (IoT) protocols, etc.). In this regard, the system 100 may include a broadcast downlink transmitter 110 that communicates with UE 120 via a first communication protocol that is typically a complex broadcast waveform (e.g., ATSC 3.0). The communication link (i.e., downlink 112) between the broadcast downlink transmitter 110 and the UE 120 is one-way from the broadcast downlink transmitter 110 to the UE 120, and it is assumed that the UE 120 employs communications antennas and/or radios that enable reception and decoding of the signal (i.e., the complex broadcast waveform) provided via the downlink 112.

Although ATSC 3.0, which is one example of an Advanced Television System Committee standards broadcast medium, is specifically mentioned above as being an example of the complex broadcast waveform that may be generated by the broadcast downlink transmitter 110 for the downlink 112, it should be appreciated that other broadcast signals may alternatively be employed. Thus, for example, other digital television broadcast standards such as DVB (Digital Video Broadcasting), ISDB (Integrated Services Digital Broadcasting), and/or the like, may alternatively be employed. Moreover, broadcast signals need not necessarily employ complex broadcast waveforms. In this regard, for example, Bluetooth Low Energy (BLE) may be transmitted as the downlink 112 in some examples. In such cases, the broadcast downlink transmitter 110 may be operating in a Bluetooth advertising mode, which may employ BLE to transmit long distances (on the order of several miles) in a broadcast capacity. Meanwhile, ATSC 3.0 employs orthogonal frequency-division multiplexing (OFDM) modulation with very high bit rates (e.g., >50 Mbit/s) on high bandwidth channels (e.g., >5 MHZ). Typically bit rates will be no lower than 20 Mbit/s on the downlink 112 and may vary widely (but typically be different) on the uplink 122. ATSC 3.0 is generally limited to 64 physical layer pipes (PLP), which may be combined together to form a channel delivering robust content. In this regard, for example, video data may be provided over one PLP in a channel with further enhanced data (e.g., to enable high definition (HD) or ultra-high definition (UHD)) being provided in one or more other PLPs of the channel.

The distinction of PLPs within a channel in ATSC 3.0 could also (or alternatively) be used to send “other” information that is not specifically related to the ostensible purpose of the channel. For example, broadcast video data could be provided in one or more PLPs of a given channel, while one or more other PLPs of the same channel could provide data or signaling for emergency response paging, activation or instruction. Accordingly, viewers of broadcast television in an area could watch television programming decoded from the broadcast signaling on the given channel, while first responders (and their UEs) may receive paging message traffic from the same channel (via another PLP). In still other cases, the paging message traffic may be encoded directly into (e.g., modulated onto) the broadcast television signaling. In short, the ATSC 3.0 standard enables a rich array of options for serving a broadcast television audience within a given regional area where a network of broadcast towers (e.g., each of which may be an instance of the broadcast downlink transmitter 110) exist, and also providing additional services not associated with broadcast television, without any hardware changes (or at least with insignificant hardware changes). Moreover, particularly since broadcast television coverage is already extensive and basically nationwide at this moment in time, the provision of the SDN and SDR techniques described herein, and the SNOC functionality, allows a further leveraging of existing assets to the hardening of national infrastructure security, the enhancement of first response capability, and to potentially numerous other valuable services with much smaller outlays of cash than would otherwise be required if entirely new infrastructure was dedicated to the tasks (not to mention entirely new spectrum).

The communication link (i.e., uplink 122) from the UE 120 is formed between the UE 120 and an uplink base station 130 (or cell). The uplink 122 may be two-way in nature, although communications specific to operation of the communication system 100 may only require the uplink direction from the UE 120 to the uplink base station 130 to be utilized in some cases. The uplink base station 130 may be part of either a local, regional or nationwide network that, in any case, employs (or at least is capable of accessing) a first IP-based connection 132 to an IP-based backhaul 140. The IP-based backhaul 140 (or backhaul network) may be any backhaul that is IP-based, such as the internet, a wide area network (WAN), or the like. Moreover, in some cases, the IP-based backhaul 140 may be provided by a nationwide network such as a cellular, air-to-ground (ATG) or other network with backhaul that is both IP-based and is fairly broad in terms of its coverage area. The IP-based backhaul 140 may be operably coupled to the broadcast downlink transmitter 110 via a second IP-based connection 142, and the first and second IP-based connections 132 and 142 may be provided by wired links, fiber optic links, or any other suitable backhaul communication links.

In an example embodiment, SNOC 150 may be located in or otherwise operably coupled to the IP-based backhaul 140. The SNOC 150 may provide network control at a cross-network level. Accordingly, whereas NOCs are well-known, and typically control a particular network, the SNOC 150 is capable of cross network communication, but further configured to dynamically control networks to maintain the asymmetric aspect of the system 100 while employing potential links associated with different networks that may each have different communication protocols associated therewith. Moreover, the SNOC 150 may not only provide control that enables communication with the UE 120 via different downlink 112 and uplink 122 link protocols and networks, but further provide support for UE 120 mobility through the handover of the UE 120 cross network to different (and dissimilar in many cases) networks and devices that may be capable of forming the downlink 112 or the uplink 122 (and that have connection to the IP-based backhaul 140). The SNOC 150 may therefore handle a number of intra-network control functions including, for example, network designations, handover mobility, interfaces with sub-network core elements, control flow, load balancing between networks, and/or the like. The SNOC 150 may also control the UE 120 with respect to directions regarding the time, place and method by which to send data up to the SNOC 150 via the uplink.

The uplink base station 130 may be a base station of any one of a plurality of different wireless communication networks employing any of a plurality of different network communication protocols. Moreover, when the UE 120 is mobile and requires handover, the uplink base station 130 may handover to a different base station associated with any one of multiple different communication networks. Some examples of other networks that could be handover destinations (with respective instances of uplink base stations in each) are shown in FIG. 1A, and may include a satellite network 160, a public safety network 170 and a cellular network 180. However, other networks could alternatively or additionally be available for use in other embodiments. Moreover, the UE 120 may be capable of communicating with any or all of such networks via their respective base stations, and may do so responsive to instruction from the SNOC 150 for mobility purposes as described herein. Whereas conventional terrestrial networks typically conduct handovers under control of the UE 120, example embodiments may provide that control via the SNOC 150.

Additionally, the SNOC 150 may, in some cases, arrange for communication with the UE 120 via the uplink 122 and/or downlink 112 from multiple assets simultaneously. Simultaneous communication may enable network aggregation (as opposed to carrier aggregation, which is for carriers in a single network). Thus, for example, the satellite network 160, the public safety network 170 and the cellular network 180 (or multiple broadcast transmitters) may each communicate with the UE 120 simultaneously and their respective signals (or contents provided thereon) may be aggregated for improved accuracy and reliability. Moreover, when all network communications are terrestrial (albeit over different networks), the communications will generally experience very low and nearly imperceptible amounts of latency.

The nation is currently nearly fully covered by public and private broadcast television transmission towers. Similarly, many different cellular networks provide redundant nearly nationwide coverage options for uplink transmission. Notably, the uplink transmission in example embodiments is primarily used for network control and is not mainly used for content provision (although content can also be provided via the uplink 122). By employing the SNOC 150 to coordinate network control and usage of these existing assets in a novel way to define a super network or network of networks, a highly reliable network for communication with assets beyond visual line of sight may be provided with great potential for expansion into new functional capabilities with secure communications. Moreover, instead of dedicating communication or network assets/bandwidth to channel management and link handover capabilities, handovers may be conducted using the links themselves.

During operation, the SNOC 150 may provide signaling including a notification, content or instructions for communication to the UE 120 via a first IP message 190. The first IP message 190 may be an IP message that is received, processed and then used to generate a broadcast message 192 (e.g., in the form of the complex broadcast waveform or BLE transmission) for communication to the UE 120. The UE 120 may receive and process the broadcast message 192 and take any of various action associated with (or instructed by) the broadcast message 192. The UE 120 may then provide any required uplink communications to the uplink base station 130 via an uplink message 194. Thereafter, a second IP message 196 may be provided to from the uplink base station 130 to the SNOC 150.

Although the immediately preceding scenario suggests origination of communication at the SNOC 150, with the broadcast downlink transmitter 110 thereafter apparently initiating contact with the UE 120, communication could alternatively be initiated from the UE 120. Thus, for example, either the UE 120 or the SNOC 150 could initiate communication either for initial attachment or registration of the UE 120 with the SNOC 150, or for delivery of a particular message, instruction, notification, etc. Moreover, although FIG. 1A shows a single instance of the UE 120, the broadcast downlink transmitter 110 and the uplink base station 130, it should be appreciated that the architecture shown may support communication with many UEs. Furthermore, the architecture shown may be duplicated many times over across large geographic regions defining a super network in which many different networks may be integrated by the SNOC 150 to provide uplink and downlink communications as described herein.

It should also be appreciated that, although FIG. 1A exclusively deals with a situation in which the downlink 112 is provided via broadcast signaling (e.g., ATSC 3.0 or BLE), the downlink 112 need not be limited to the exclusive domain of broadcast signaling. Thus, for example, FIG. 1B illustrates an alternative scenario in which a duplex downlink 112′ is provided via a downlink transmitter 110′ instead of a broadcast link via the broadcast downlink transmitter 110 of FIG. 1A. The duplex downlink 112′ is still asymmetric that that the uplink 122 is still provided by a different communication link. In some cases, the duplex downlink 112′ may be, for example, a thin communication pipe or link with a relatively low bandwidth and/or large delay that makes the duplex downlink 112′ generally undesirable for real time or delay sensitive services that require a fast response, thereby making the employment of the uplink 122 advisable or preferable. Other than changing the downlink 112 to the duplex downlink 112′ (and the downlink transmitter 110′ that provides it), the other components of the architecture shown in FIG. 1B may be the same as those of FIG. 1A. More details regarding some example scenarios will be provided below.

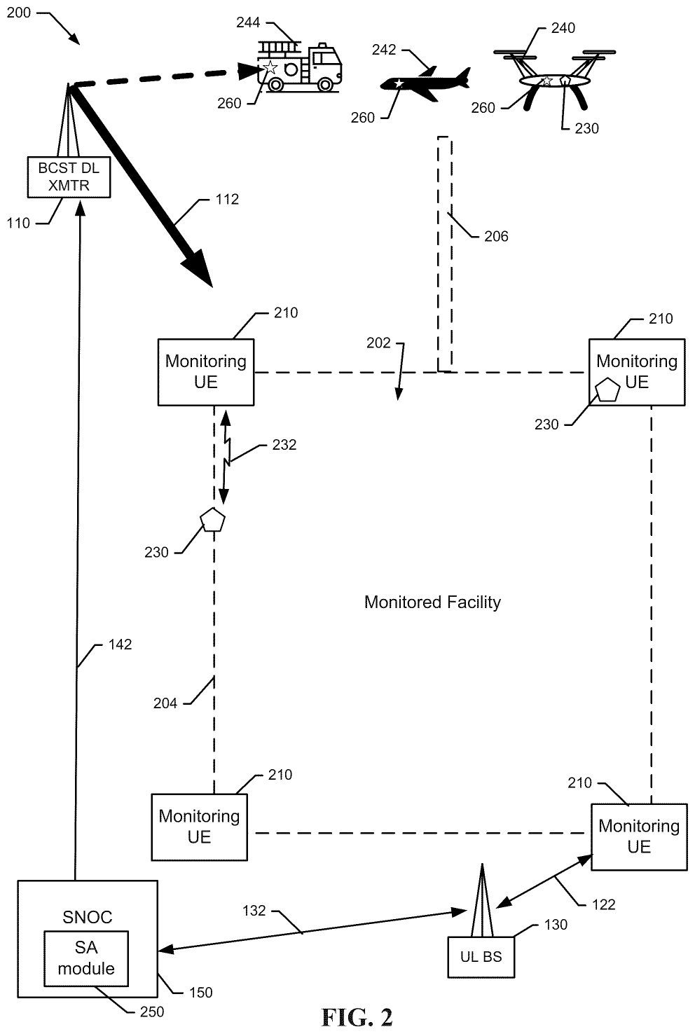

In this regard, for example, FIG. 2 illustrates one specific example scenario involving remote monitoring or unmanned monitoring. As shown in FIG. 2, a monitoring system 200 may provide monitoring for a monitored facility 202. The monitored facility 202 (or area) may have a border 204 and, in some cases, may further include supported hardware 206 that extends outside the border 204 of the monitored facility 202. The monitored facility 202 may be, for example, a power grid sub-station, a power plant, a military base, a school, a private home or business, a region (e.g., a park, farm or country), or any other infrastructure or other asset or place for which monitoring is desirable. The border 204 may therefore be, for example, a fence, a wall, a natural barrier (e.g., mountain range, stream/river/lake/ocean, forest edge, field edge, etc.), or an arbitrarily or otherwise defined geographic region. The supported hardware 206 may include componentry, wires, pipes, and/or the like that extend from the monitored facility 202 and are operably coupled thereto for some functional reason. As an example, if the monitored facility 202 is a power grid sub-station, the supported hardware 206 may include power lines that extend to or from the power grid sub-station. If instead the monitored facility 202 is an oil refinery, the supported hardware 206 may include pipeline that extends into or out of the refinery.

In an example embodiment, the monitored facility 202 may have one or more instances of a monitoring UE 210 located proximate thereto. In the depicted example of FIG. 2, there are four instances of the monitoring UE 210, and each respective one of the four instances of the monitoring UE 210 is located at a respective corner of the border 204 of the monitored facility 202. However, it will be appreciated that more or fewer instances of the monitoring UE 210 may be provided at the monitored facility 202 at any suitable location. Moreover, in many instances, only one instance of the monitoring UE 210 may be needed to effectively secure or monitor the monitored facility 202. Further discussions of this example with therefore reference only a single instance of the monitoring UE 210 for purposes of simplifying the discussion.

Within this context, the broadcast downlink transmitter 110 of FIG. 1A may transmit signals for the downlink 112 to the monitoring UE 210. The downlink 112 may provide command and control messaging to the monitoring UE 210 to, for example, dictate specific functions and the timing of execution of such functions for the UE 210 beyond the visual line of sight. However, because the downlink 112 is provided via the complex broadcast waveform, the waveform itself, independent of its specific content, may also be used by the monitoring UE 210 (or other local componentry) for specific security related services. In this regard, as will be discussed in detail below, the complex broadcast waveform itself may be monitored and analyzed as passive radar.

Upon receipt and processing of the content of the downlink 112 from the broadcast downlink transmitter 110 (and ultimately from the SNOC 150), the monitoring UE 210 may perform any actions or functions directed by instructions included in the content. In some cases, the actions may include the acknowledgement of receipt of the instructions via the uplink 122 to the uplink base station 130. The uplink base station 130 may then communicate (e.g., via the first IP-based connection 132) to the SNOC 150.

In an example embodiment, the uplink 122 may be used to communicate information gathered at or about the monitored facility 202. The information gathered may generally be referred to as environmental information, which may ultimately provide situational awareness regarding the current conditions and activity at the monitored facility 202. In some embodiments, a network of sensors 230 may be disposed at various locations in and around the monitored facility 202. In this regard, as shown in FIG. 2, some instances of the sensors 230 may be located at or collocated with the monitoring UE 210. Other instances of the sensors 230 may be located at specific locations of the monitored facility 202 such as, for example, on the border 204 (or on the supported hardware 206). When separated from the monitoring UE 210, the sensors 230 may be operably coupled to the monitoring UE 210 via short range wireless communication links 232 (e.g., Bluetooth) or wired connections. In still other cases, the sensors 230 may be on vehicles that may be associated with the monitored facility 202. In this regard, for example, one instance of the sensors 230 is shown on a drone 240 (or other unmanned aerial vehicle (UAV), which is one example of a vehicle that may be associated with the monitored facility 202. Other vehicles on which sensors 230 could be provided include another aircraft 242 (e.g., fixed wing aircraft), and a ground transport vehicle 244 such as a robotic rover, first responder vehicle, security vehicle, military vehicle and/or the like.

The sensors 230 may include any of a plurality of different types of sensors that may be of use with respect to particular information or purposes associated with the monitored facility 202. For example, in the context of security, the sensors may include motion sensors, cameras, gate/door position sensors, and/or the like. However, in some cases the sensors 230 may also or alternatively include sensors that gather weather information. As such, the sensors 230 may include temperature sensors, atmospheric pressure sensors, humidity sensors, precipitation sensors, wind speed sensors, visibility sensors, and/or the like. Given the multiple locations, and in some cases also multiple altitudes, around the monitored facility 202 that the sensors 230 may be located, the environmental information that can be provided to by the sensors 230 may present a thorough set of data upon which detailed analysis may be performed either in real time, or post hoc.

In some embodiments, a situational awareness (SA) module 250 may be provided at or near the SNOC 150 to receive, store, process or otherwise handle the environmental information received via the uplink 122 from the monitoring UE 210. The SA module 250 may be configured to process all of the environmental information received thereby, or the SA module 250 may include sub-modules associated with respective different types of environmental information. Thus, for example, when the SA module 250 is associated with a plurality of instances of the monitored facility 202 at various locations within a region, an ability to fuse environmental information from all such locations becomes possible. Particularly for power grid sub-stations, which are distributed all over the country at various intervals, but also for any number of other potential installations or facilities that may also be monitored in an area, a near continuous network of monitoring stations (i.e., monitored facilities 202) across a city, county, state, or even the whole country may be effectively used for gathering environmental information. The environmental information gathered may then be employed to evaluate weather conditions and specific other conditions (i.e., relating to threats or actions of terrorists, hooligans, or other actors), as a patchwork of data from the comprehensive network of environmental data that can then be fused together into one cohesive picture by the SA module 250 (or groups of SA modules).

Regarding weather condition determination specifically, in some cases, the use of the complex broadcast waveform may enhance the ability to obtain accurate weather data. In this regard, for example, received signals at the drone 240 may change as altitude of the drone changes based on different wind or weather conditions at respective different altitudes. Moreover, the effort required for the drone 240 to hold station or make headway in each location, and at each respective altitude may also provide accurate indications regarding wind speed at the corresponding locations and altitudes. Wind sensors may also or alternatively be provided on the drones 240 or other equipment. In any case, measurement of changes experienced at the drone 240 in either or both of signal quality and power consumption may be useful to define wind profiles using signal, wind or current sensors at low altitudes (e.g., less than 2000 ft, or even less than 400 ft).

In relation to signal analysis being used to determine wind or other weather conditions, it should be appreciated that the UE 210 may be capable of receiving signals from multiple different sources (e.g., the downlink broadcast transmitter 110, the uplink base station 130, other candidate uplink base stations, etc.) and each source may have different signals (e.g., carriers) associated therewith. Each signal may be impacted or effected differently by wind and weather. Thus, in some cases, the SNOC 150 (and more specifically the SA module 250) may receive signal reception parameters associated with each received signal from the UE 210. The SNOC 150 may then compare changes in signal strength, signal quality, or any other perceptible change in the signal reception parameters in order to make inferences or determinations about wind and/or weather experienced at the location of the UE 210. The SNOC 150 may record such information to provide, as noted above, wind profiles or other detailed weather information profiles that can be location specific in two and/or three dimensions in real time. Given the backhaul capability for such information even from remote locations, a very detailed weather, wind or other environmental picture may be generated that is updated and maintained in real time or near real time nationwide.

The processing performed by the SA module 250 may be tailored to the specific purposes desired by the operator of the monitoring system 200, and therefore may be varied. However, in some embodiments, the monitoring system 200 may include at least one desired function related directly to security for the monitored facility 202. In such a situation, the SA module 250 may be focused on processing the environmental information for detection of abnormal situations or threats related to the security or safety of the monitored facility 202 and in some cases also the supported hardware 206. Abnormal situations or threats, once interpreted, may trigger deployment of first responders, or other response assets. Moreover, in some cases, the drone 240, aircraft 242, and/or the ground transport vehicle 244 may be launched or dispatched in response to the trigger condition. The drone 240, the aircraft 242 and/or the ground transport vehicle 244 may also employ an instance of a UE 260, each of which can be separately paged, instructed and/or controlled via the monitoring system 200.

In one example, the monitoring UE 210 may employ one or more of the sensors 230 to utilize passive radar monitoring of the monitored facility 202 (via processes described in greater detail below), to detect an environmental change classified as a threat or a trigger condition. The detection of the trigger condition may in turn cause, for example, the launch of the drone 240. The drone 240 may then employ its own instance of the sensors 230 to, for example, investigate a particular target of interest or threat, or surveil the border 204 and/or supported hardware 206. Thus, for example, if the monitored facility 202 is a power grid sub-station and power is lost such that the SNOC 150 (and/or SA module 250) detects the power loss as a trigger condition, the downlink 112 may be used to instruct the drone 240 to launch. The instructions provided by the downlink 112 may further detail specific areas to employ the sensors 230 with respect to determining a cause of the trigger condition, or otherwise performing a function responsive to the trigger condition. Accordingly, video data may be recorded of the area around the fencing (i.e., border 204) of the sub-station and/or the drone 240 may fly a route tracing the power lines (i.e., supported hardware 206) to determine if a downed tree or other object has interfered with the integrity of the power lines. If a tree has fallen on the power lines, the specific location of the tree may be reported via the uplink 122 and, in some cases, video data of the scene may be transmitted (again via the uplink 122) to the SA module 250 for provision to first responders or maintenance crews that are enroute to the scene. The provision of the specific location and/or the video data may also be provided by the monitoring system 200 (e.g., via the downlink 112) to UEs (e.g., UE 260) associated with the first responders or maintenance crews.

The sensors 230 carried on aircraft (e.g., the drone 240) may also enhance the capability of the system 200 to gather weather information from the ground and up to low altitudes (e.g., less than 5000 ft., but more often less than 2000 ft. or even 400 ft.). For example, various ones of the sensors 230 may detect temperature, pressure, wind speed and various other parameters directly. However, indirect measurements may also be made in some cases. In this regard, wind speed may offset the drone 240 or impact its speed over ground, and can be inferred based on air resistance measured relative to power expended. Moreover, the environment itself may impact the complex broadcast signal in some cases, and provide indirect indications of weather conditions. For example, the presence of high humidity or rain may impact the received signal in a way that is noticeable and therefore may indicate information about the weather when such impacts are detected.

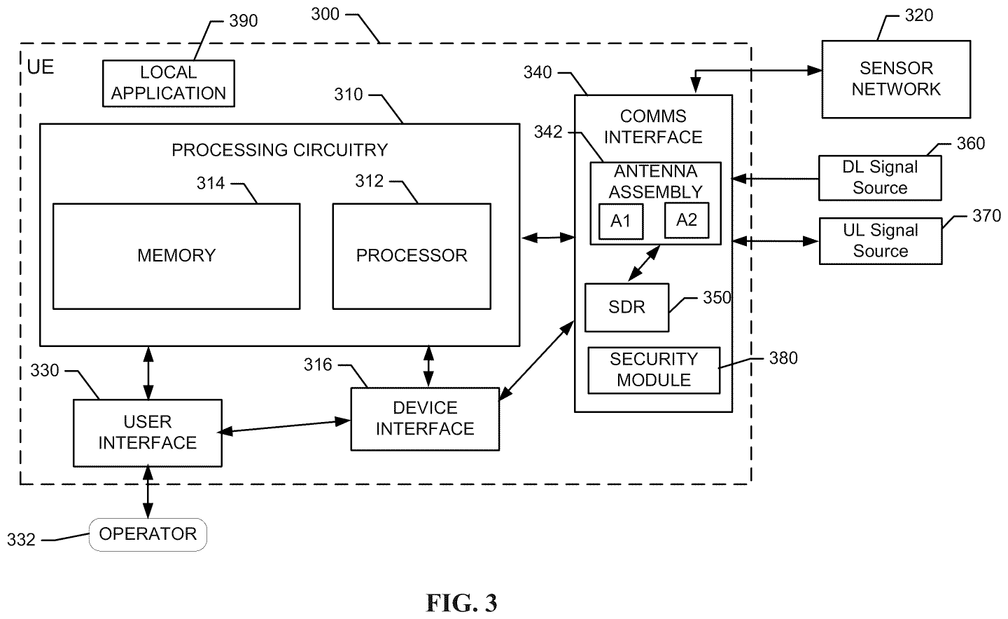

FIG. 3 illustrates a block diagram of a UE 300 in accordance with an example embodiment. The UE 300 should be understood to illustrate componentry of the UE 120 of FIG. 1A, the monitoring UE 210 of FIG. 2, and/or the UEs 260 of FIG. 2. As shown in FIG. 3, the UE 300 may include processing circuitry 310 configured to perform data processing, control function execution and/or other processing and management services according to an example embodiment of the present invention. In some embodiments, the processing circuitry 310 may be embodied as a chip or chip set. In other words, the processing circuitry 310 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 310 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 310 may include one or more instances of a processor 312 and memory 314 that may be in communication with or otherwise control a device interface 316. As such, the processing circuitry 310 may be embodied as a circuit chip (e.g., an integrated circuit chip) configured (e.g., with hardware, software or a combination of hardware and software) to perform operations described herein. In some embodiments, the processing circuitry 310 may communicate with various internal and/or external components, entities, modules and/or the like, e.g., via the device interface 316. The processing circuitry 310 may also communicate with one or more instances of either sensors (e.g., sensors 230 from FIG. 2) or electronic devices associated with the region at which the UE 300 is located. These sensors or devices may be part of a sensor network 320. The sensor network 320 may provide environmental information about weather conditions (e.g., at the monitored facility 202) based on actual observation (as opposed to reports from weather services). Thus, for example, the sensor network 320 may include thermometers, atmospheric pressure sensors, rain gauges, light sensors, cameras, and/or the like for determining weather conditions. However, it should be appreciated that sensors like cameras may have other uses as well, such as providing remote operators (or pilots) with real-time views of conditions at the monitored facility 202 as noted above. The sensors (such as movement sensors or the camera) may also indicate when animals, humans, vehicles or other obstructions are impacting the environment around the monitored facility 202.

The device interface 316 may include one or more interface mechanisms for enabling communication with other internal and/or external devices (e.g., modules, entities, sensors and/or other components). In some cases, the device interface 316 may be any means such as a device or circuitry embodied in either hardware, or a combination of hardware and software that is configured to receive and/or transmit data from/to modules, entities, sensors and/or other components that are in communication with the processing circuitry 310. In this regard, for example, the device interface 316 may be configured to operably couple the processing circuitry 310 to the sensor network 320, and/or to various external entities or components (including flight control entities, aircraft themselves, weather services, etc.) that may provide various types of information including traffic information, weather information, and numerous other types of information associated with the monitored facility 202 and services associated therewith.

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry—in the form of processing circuitry 310) capable of performing operations according to embodiments of the present invention while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform the operations described herein.

In an example embodiment, the processor 312 (or the processing circuitry 310) may be embodied as, include or otherwise control the operation of the UE 300. As such, in some embodiments, the processor 312 (or the processing circuitry 310) may be said to cause each of the operations described in connection with the UE 300. The processor 312 may also control function execution and instruction provision related to operations of the UE 300 based on execution of instructions or algorithms configuring the processor 312 (or processing circuitry 310) accordingly. In particular, the instructions may include instructions for configuring radios, antennas or the like to communicate via any of the network protocols that may form uplink 122 and downlink 112 options for example embodiments. Instructions may also include guidance for reporting of environmental information, controlling local lighting, alarms, or other security measures, and/or the like.

In an exemplary embodiment, the memory 314 may include one or more non-transitory memory devices such as, for example, volatile and/or non-volatile memory that may be either fixed or removable. The memory 314 may be configured to store information, data, applications, instructions or the like for enabling the processing circuitry 310 to carry out various functions in accordance with exemplary embodiments of the present invention. For example, the memory 314 could be configured to buffer input data for processing by the processor 312. Additionally or alternatively, the memory 314 could be configured to store instructions for execution by the processor 312. As yet another alternative, the memory 314 may include one or more databases that may store a variety of data sets associated with the local activity information, weather information and/or other services that can be provided by the UE 300. Among the contents of the memory 314, applications and/or instructions may be stored for execution by the processor 312 in order to carry out the functionality associated with each respective application/instruction.

In some cases, the UE 300 may also include a user interface 330. The user interface 330 may be in communication with the processing circuitry 310 to receive an indication of a user input (e.g., from operator 332) at the user interface 330 and/or to provide an audible, visual, mechanical or other output to the operator 332. As such, the user interface 330 may include, for example, a keyboard, a mouse, a joystick, a display, a touch screen, a microphone, a speaker, augmented/virtual reality device, or other input/output mechanisms. In embodiments where the UE 300 is embodied as a passive radar sensor, or is located at a drone or other vehicle, the user interface 330 may be limited or even eliminated in some cases. Alternatively, as indicated above, the user interface 330 may be remotely located to permit remote operation of the drone or vehicle.

One example of an application that may be controlled by instructions stored in the memory 314 and executed by the processor 312 may include an application for providing a communications interface 340. The communications interface 340 may include hardware (e.g., an antenna assembly 342, which may include one or more antenna arrays (e.g., A1 and A2). The antenna assembly 342, and/or its antenna arrays, may be operably coupled to respective radios to allow transmission and reception of signals via the antenna assembly 342. In an example embodiment, the communications interface 340 may include a software defined radio (SDR) module 350 that can provide for agile reconfiguration of the antenna assembly 342 and/or other radio components to permit reconfiguration of the communications interface 340 to communicate with available networks via a downlink signal source 360 (e.g., the downlink 112 provided by the broadcast downlink transmitter 110) and/or an uplink signal source 370 (e.g., the uplink 122 provided by the uplink base station 130). The SDR module 350 therefore enables the communications interface 340 (and by extension also the UE 300) to be protocol agnostic to a large degree. The degree to which the UE is protocol agnostic may be limited only by the capabilities of the SDR module 350 to configure the antenna assembly 342 to process signals of a given protocol.

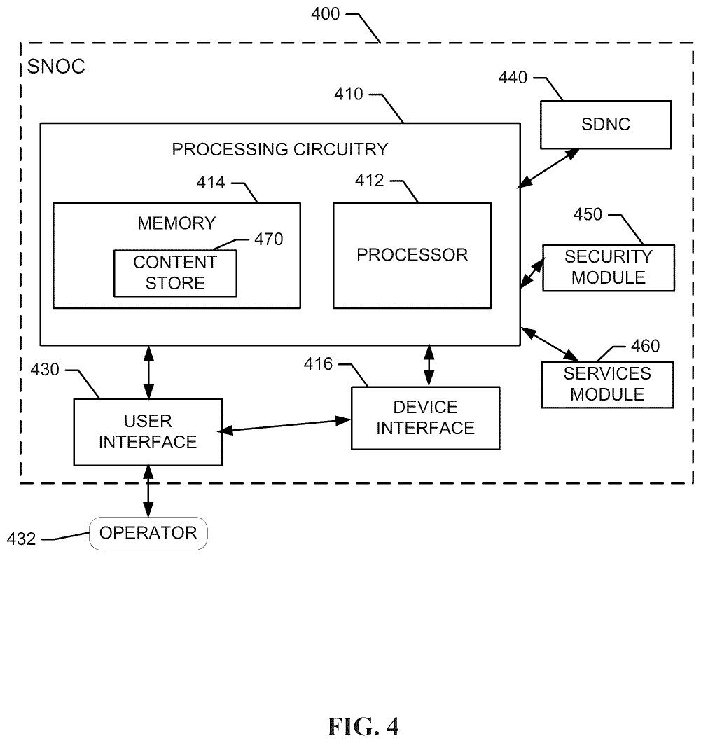

In an example embodiment, the asymmetric nature of the communications of the UE 300 may facilitate enhanced security since the asymmetry is not only with respect to data rates, but actually uses dissimilar networks for the uplink 122 and downlink 112. This fact may be leveraged further by the provision of a security module 380. The security module 380 may interface with a corresponding security module 450 (see FIG. 4) of the SNOC 150 to coordinate sharing encryption keys (which may themselves be asymmetric), coordinate targeted broadcast messaging (e.g., by directing the UE 300 to a particular different channel using the currently active channel), or otherwise provide enhanced security services.

In an example embodiment, the UE 300 may also include a local application 390 that is executed to define a specific set of functions or tasks for the UE 300. In this regard, whereas the UE 300 may be as basic as a pager device in some cases, in other cases, much more complexity and functionality may be incorporated into the UE 300 or the device at which the UE 300 exists. The local application 390 may include application programming interfaces (APIs), function calls, algorithms, and/or other executable instructions or programming that enable the UE 300 to perform corresponding functions or tasks controlled thereby. In some examples, where the UE 300 is employed by first responders and, as noted above, the UE 300 may initially function as a paging device to notify selected first responders of an event. In such a case, the UEs of the selected first responders may receive a paging notice over a paging channel that may be dedicated to paging services. However, as noted above, paging notifications could alternatively simply be provided via one PLP of a channel otherwise used for other functions (e.g., broadcast television), or could be modulated onto the broadcast television signal. The paging notification may therefore come via the downlink 112, and the UE 300 may acknowledge receipt of the paging notification via the uplink 122. In some cases, the downlink 112 may further be utilized to provide detailed instructions or content to the first responders. In such cases, the UE 300 may be instructed to obtain the detailed instructions or content on a different channel. The detailed instructions or content may include instructions specific to the scene that the first responders are to report to, instructions for actions to be taken upon arrival, video content of the scene, etc. In such cases, the local application 390 may provide capabilities for decoding/decrypting associated messages, locating the messages in a series of possible channels with different content and different encryption, and rendering the content via the user interface 330 of the UE 300.

In some cases, the local application 390 may include tools for processing instructions for command and control of an aircraft or drone. Thus, for example, if the UE 300 is located at the drone 240, and the drone 240 is instructed to launch responsive to a security trigger, or other scheduled or managed maintenance or security activity, the local application 390 may further enable remote or autonomous control of the drone 240 after launch for the collection of video and sensor data, image capture, deterrence missions, or other functional activities. In this regard, for example, if the monitored facility 202 is a farm, services associated with delivering chemicals or water, or collecting specific data on crop health or growing conditions may all be executed by the local application 390 of the drone 240. In this regard, the drone 240 may obtain status information associated with security or maintenance checks that would otherwise be required to be conducted by human actors on site. The drone 240 (or another vehicle) may therefore be controlled with respect to any of various activities in association with many different contexts. The command and control provided by the asymmetric nature of the systems 100 and 200 may not only leverage mainly existing, but multi-purpose assets, but may do so with a high level of security and reliability for the communication links involved. Other local application 390 functions may also be included such as passive radar, and location determination.

In the case of location determination, the UE 300 may determine its location based on utilization the complex broadcast waveform (e.g., ATSC 3.0 signal) for a GPS alternative. In this regard, the ATSC 3.0 signal may include timing information that is extremely accurate. When the UE 300 receives broadcast signals from multiple transmitters (i.e., multiple instances of the broadcast downlink transmitter 110), the UE 300 may (via the local application 390) calculate distance from each of the multiple transmitters accurately. When at least three transmitters can be received, and distances thereto calculated, an accurate (and potentially three dimensional) location of the UE 300 may be calculated. Accordingly, to the extent a GPS denial event is encountered, the UE 300 may provide accurate location services (via the local application 390), or may enhance location determination in other cases, if desired. The UE 300 may perform location determination in a stand-alone capacity, or assistance may be provided by the SNOC 400.

Turning now to FIG. 4, a block diagram of a SNOC 400 is shown, which illustrates an example of the SNOC 150. Moreover, FIG. 4 illustrates some example componentry that may be used in the SNOC 400 in some cases. Of note, the processing circuitry 410, processor 412, memory 414, device interface 416, and user interface 430 may have similar form and/or functional capabilities to that already described above in reference to the processing circuitry 310, processor 312, memory 314, device interface 316, and user interface 330. Thus, specific descriptions of these components are not necessary. However, to the extent the user interface 430 is included, the operator 432 may be a network operator or actor that is associated with controlling or initiating functions executable via the systems 100 and 200 described above. Additionally, although the processor 412 and memory 414 may be individual respective components, the memory requirements and processing capacity requirements for the SNOC 400 may in some cases be immense (e.g., if the SNOC 400 serves a very high number of UEs and uplink/downlink assets). Thus, in some cases, the processor 412 and memory 414 may represent banks of such components, servers, or server banks that may form, for example, a super data center capable of storing and processing cross network information at very high speeds and in very high quantities in a relatively short time. Machine learning, neural networks or other processing tools may be employed to facilitate finding patterns in the environmental information received across different networks.

In an example embodiment, the SNOC 400 may include a software defined network controller (SDNC) 440. The SDNC 440 may be configured to provide instructions to various disparate network assets with respect to configuring those assets for participation in the asymmetric communications described herein. Thus, for example, the SDNC 440 may provide a protocol agnostic capability for defining network links (e.g., the uplink 122) using any available network assets in a region that are compatible with the capabilities of the UE 300. In this regard, for example, in some embodiments, the UE 300 may initially register with the SNOC 400 and communicate its capabilities to the SNOC 400 upon initial registration, as well as providing its location. When the SNOC 400 (and more particularly the SDNC 440) is aware of the capabilities and location of the UE 300, the SDNC 440 may be used to interact with the broadcast downlink transmitter 110 that is in the region of the UE 300 (i.e., has a coverage area extending to the location of the UE 300), and provide paging notifications or other message traffic and content that is intended for the UE 300 to the broadcast downlink transmitter 110 of that area. The SDNC 440 may also configure the SNOC 400 to communicate with any of various candidates assets for functioning as the uplink base station 130 by operating at the network layer of the OSI model to define a master or super network layer that can implement resources of other networks within range of the UE 300 and within the capability of the SNOC 400 and the UE 300 to communicate. The security module 450 may, as noted above, interface with the security module 380 of the UE 300 or otherwise interact with network assets to implement security measures with respect to the communication links themselves.

In an example embodiment, the SNOC 400 may also include a services module 460, which may include algorithms, programming, control functions, etc., for directing various assets of the systems 100 and 200 in connection with their interactions with the systems 100 and 200. To the extent multiple services of different types are provided, the services module 460 may, in some cases, include sub-modules dedicated to each respective different type of service provided.

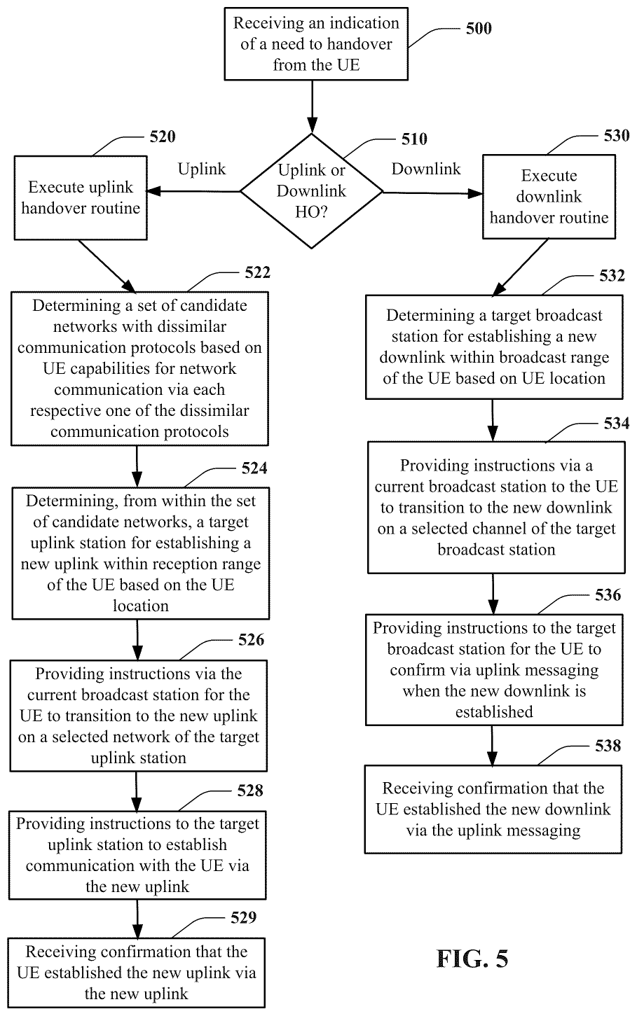

One of the services that may be provided by the services module 460 may relate to the provision of device (specifically UE) mobility. UE mobility must be accommodated by defining capabilities for handing over UEs that are moving to other assets that can act as either uplink or downlink sources. On both the uplink 122 and the downlink 112 side, the SNOC 400 may receive information indicative of the location of the UE 300 as a necessary part of any handover procedure. This location information may be provided directly by the UE 300 (e.g., based on GPS data obtained by the UE 300, ATSC 3.0 timing-based location determination, or the like) in some cases. The purpose of the location information may be to determine which target assets (i.e., new downlink transmitter candidates or uplink receiver candidates) are most appropriate to maintain link continuity for the UE 300 going forward, based on the UE's location and perhaps also its future movement. However, unlike a normal handover within a single network, where interoperability with all adjacent cells is assumed with certainty, the SNOC 400 is capable of coordinating handovers among networks that employ dissimilar communication protocols. Thus, the capabilities of the UE 300 for communication via each of these dissimilar networks must also be considered. FIG. 5 illustrates a method of conducting a handover of the UE 300 in an asymmetrical communication super network that includes different networks among candidates (at least for the uplink 122).

In this regard, as shown in FIG. 5, the method may include receiving an indication of a need to handover from the UE at operation 500. The indication may be based on the signal strength received from the downlink transmitter (on the downlink 112). On the uplink side, although the information leaving the UE forms the uplink 122, it is noteworthy that the UE may have a two way connection to the asset (e.g., uplink base station 130) providing the uplink 122. Thus, the UE may also have an indication of signal strength received from the uplink base station 130 as well, and that signal strength may also be measured relative to a threshold for requesting a handover. Regardless of the details for providing the indication, the method may further include determining whether the indication corresponds to an uplink handover or a downlink handover at operation 510. Thereafter, responsive to determining that the indication corresponds to the uplink handover, an uplink handover routine may be executed at operation 520. Responsive to determining that the indication corresponds to the downlink handover, a downlink handover routine may be executed at operation 530. Although perhaps rare, it should be noted that both an uplink and a downlink handover may be conducted simultaneously in some cases. Moreover, FIG. 5 is also exemplary of one possible handover method that may be employed with example embodiments, and some examples may modify or augment the method above in various details.

The uplink handover routine may include determining a set of candidate networks with dissimilar communication protocols based on UE capabilities for network communication via each respective one of the dissimilar communication protocols at operation 522 and determining, from within the set of candidate networks, a target uplink station for establishing a new uplink within reception range of the UE based on the UE location at operation 524. The routine may further include providing instructions via the current broadcast station for the UE to transition to the new uplink on a selected network of the target uplink station at operation 526, providing instructions to the target uplink station to establish communication with the UE via the new uplink at operation 528, and receiving confirmation that the UE established the new uplink via the new uplink at operation 529.

The uplink handover routine can be appreciated to require knowledge of the capabilities of the UE 300 with respect to communication with dissimilar communication protocols. Thus, for example, in some cases the UE 300 may be required to inform the SNOC 400 of its capabilities when the UE 300 initially registers on the super network (i.e., with the SNOC 400). The SNOC 400 may store a capabilities listing for each UE that is registered with the SNOC 400, and may reference the stored capabilities listing each time a handover request is received from a given UE to be sure that all handover decisions consider the stored capabilities listing.

The downlink handover routine may include determining a target broadcast station for establishing a new downlink within broadcast range of the UE based on UE location at operation 532, and providing instructions via a current broadcast station to the UE to transition to the new downlink on a selected channel of the target broadcast station at operation 534. The routine may further include providing instructions to the target broadcast station for the UE to confirm via uplink messaging when the new downlink is established at operation 536, and receiving confirmation that the UE established the new downlink via the uplink messaging at operation 538.

Of note, in some cases, operation 532 may include the provision of a notification to the UE 300 of an identity and respective channels to search for with respect to a set of candidate downlink transmitters nearby the UE 300. The UE 300 may further be instructed to look for each of the candidate downlink transmitters and report signal strength received from each. The SNOC 400 may then make the handover decision with respect to establishing the new downlink based on actual signal strength measurements received instead of or in addition to the location information regarding UE location alone. A similar paradigm may also exist on the uplink side insofar as the UE 300 being instructed to look for specific candidate uplink base stations and attempt to connect with nearby stations to report signal strength. Thus, uplink handovers may also consider not just location and capabilities, but also actual signal strength measurements.

Although FIG. 5 is descriptive of a handover initiated by the UE 300, it is also possible for the handover to be initiated by the SNOC 400. In this regard, for example, given that the SNOC 400 may be aware of assets capable of providing uplink or downlink services to the UE 300, and may also be aware of the location and movement of the UE 300, the SNOC 400 may determine when a handover is likely to be needed based on location and movement of the UE 300. However, the SNOC 400 may also initiate handovers for other reasons, such as the enhancement of security, improved passive radar performance, the optimization of content transmission using links with speed or bandwidth characteristics that are best suited for the content, etc.

The services module 460 may also provide command and control services, which may include air traffic control functions. In this regard, for example, if the UE 300 is associated with the drone 240, the UE 300 may be required, prior to becoming airborne, to upload a flight path so that airspace management (i.e., allocation of a volume of airspace for exclusive use by the drone 240 for a given period of time) may be accomplished. In many cases, the upload of the flight path may be a federally mandated requirement. Thus, registration of the UE 300 on the drone 240 may effectively be required. The capabilities, location and flight plan of the UE 300 (and all UEs) within the super network (i.e., the network of networks) may therefore be known to the SNOC 400 at all times.

In some embodiments, broadcast transmitters may have a standard hailing channel that is known for all UEs connecting to the super network. The standard hailing channel may continuously announce to all UEs within communication range the current procedures and processes for registration including channel plans (i.e., which resources or functions are associated with which channels). Thus, for example, when the UE 300 powers on (or otherwise attempts to access the super network), the UE 300 may initially reference the hailing channel. The hailing channel may direct the UE 300 to go to a specific other channel to obtain instructions for uploading flight plans. In some cases, the hailing channel may be non-encrypted, and other channels may be encrypted. Thus, the hailing channel may be used to define specific encryption to be used by a particular asset to receive particular messaging. The direction of the UE 300 to a specific channel to receive an encryption key for use with another channel, or various other security schemes may be employed to ensure secure communications.

The uploading of the flight plan may also be used by the services module 460 to define a communication plan outlining the candidate transmitters and receivers for the drone 240 during the course of its journey according to the flight plan, and further based on the network connection capabilities of the UE 300 onboard the drone 240. The channel plan may define high bandwidth channels for the UE 300 to reference for content (or backup connectivity), and lower bandwidth channels to use for tracking progress along the course of the drone 240 while journeying according to the flight plan or otherwise receiving low bandwidth, high reliability instructions for command and control. The channel plan may also define backup channels (non-encrypted) to be used by UEs that lose uplink connectivity in order to reestablish connectivity by providing instructions for finding and connecting to uplink base stations that the corresponding UEs can access based on capabilities and/or location. In this regard, link recovery procedures may be defined by the SNOC 400, and may be provided to the UE 300 via broadcast instructions on specific channels dedicated to link recovery, or responsive to UE 300 messaging via the uplink 122 indicating a loss of the downlink 112. Loss of the uplink 122 may be cured by telling the UE 300 via the downlink 112 exactly where to look and how to tune receivers or decode transmissions from particular base stations.

In some embodiments, flight plans that would cause the drone 240 to extend to region where the capabilities of the UE 300 on the drone 240 would not permit connectivity may be rejected, or proposals may be generated by the services module 460 for alternative routing that would permit continuous connectivity. Thus, for example, the services module 460 may have continuously or periodically updated coverage maps for all broadcast and reception assets in all areas covered by the super network. The coverage maps may be references, along with an understanding of the capabilities of the UE 300, to determine areas of a proposed flight plan that may create connectivity issues, and the services module 460 may employ route planning tools to suggest or even dictate alternate routing that ensures connectivity and control of the drone 240 throughout its flight path.

In an example embodiment, the services module 460 may also send identity challenges to unknown aircraft detected in an area. For example, if an aircraft that is not registered to the super network is detected, the hailing channel, or another channel for a broadcast transmitter proximate to the unknown aircraft may send instructions to the unknown aircraft to register. The challenges may direct such assets to ground themselves until registered, or direct the assets to particular air space that is known to be vacant. In other cases, failure to respond to such challenges or merely the detection of unknown aircraft in a region may cause the services module 460 to redirect flight paths of other aircraft that are impacted or were otherwise assigned air space that is now being impacted by the unknown aircraft. Thus, safety and security for multiple aircraft can be provided over a vast region.

The SNOC 400 may also have a content store 470, which may be part of the memory 414. The content store 470 may store instructions or programming for download to the UE 300, or applications (e.g., the local application 390) that can be downloaded to the UE 300. In some cases, the content store 470 may further include specific content which may be static or dynamic. The content may be provided over dedicated channels, or targeted to specific UEs by paging and then providing instructions to the specific UEs regarding encryption or channels to employ in order to obtain the specific content.

Given that the UE 300 may be one of many, many UEs over a vast region that may provide data (e.g., from sensors 230), the content store 470 may also record or store such data for analysis in real time or post hoc. In some cases, real time weather data may be provided along with location information that can provide a rich source of information about weather in three dimensions wherever UEs are located within the super network. Given that some of the UEs may be airborne, and some may be on the ground, the information may actually be three dimensional in nature, and may be updated continuously.

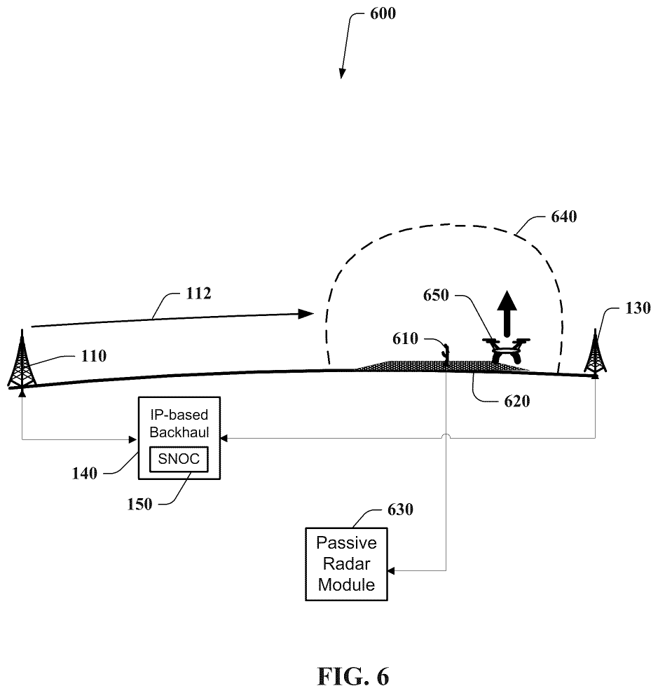

As noted above, another function that can be performed by assets in the super network may be passive radar. FIG. 6 illustrates a scenario in which passive radar techniques may be practiced in a passive radar system 600 according to an example embodiment. Referring to FIG. 6, the broadcast downlink transmitter 110 may transmit the downlink 112, which is representative of any complex broadcast waveform throughout the coverage area of the broadcast downlink transmitter 110. That downlink 112 signaling may be targeted at any number of UEs for any number of purposes throughout the coverage area. Such UEs may establish uplink connectivity via the uplink base station 130 and the IP-based backhaul 140 and SNOC 150 as described above may complete a single asymmetrical network cell of the super network.

Within this general context, a passive radar element 610 may be provided proximate to a secured facility 620. The passive radar element 610 may be a device specifically configured for passive radar activity as described herein, or may simply be an instance of the UE 300 where the local application 390 employs or is embodied as a passive radar module 630. The passive radar element 610 may include antenna equipment capable of receiving transmissions (e.g., of the downlink 112) and performing spectral analysis relative to the received transmissions. Meanwhile, the passive radar module 630 may be configured to capture snapshot spectral analysis data in frames that may be compared to each other to determine changes between frames. Thus, for example, the passive radar module 630 may include a spectrum analyzer in some cases.

In particular, complex broadcast waveforms (such as ATSC 3.0) have spectral characteristics that make the waveforms useful for employment as a reference signal. Moreover, in some cases, these signals may be conditioned with signal optimization to improve such characteristics for specific areas or weather conditions under control of the SNOC 150. The reference signal may be measured, and may be relatively steady such that the reference signal would tend to create a series of similar spectral frames when compared over time in the absence of some physical disruption. Meanwhile, when a physical object enters into an area proximate a receiver of a complex broadcast waveform, the object causes changes to spectral frames that can be observed by comparing frames. Moreover, the location of the disturbance within a series of frames can be determined and, in some cases, estimates of motion, speed and even size of the object causing the disturbance may be possible. If a trigger event is detected, an alert may be communicated to the SNOC 150, or local actions may be initiated (e.g., turning on lights, sounding alarms, activating locks, launching a drone 650 to obtain image/video/sensor surveillance data, etc.). If the SNOC 150 determines that first responder or security force response is desirable or required, the SNOC 150 may page or otherwise notify the appropriate parties via the system 100, 200 or 600.

The passive radar module 630 may capture and store spectral frames, and further conduct comparisons of spectral frames to detect objects or disturbances between frames. In this regard, if there is a difference greater than a threshold amount between adjacent frames that are compared, presence of an object may be inferred and a triggering event may be determined to exist. Thus, for example, the passive radar element 610 may have a viewing region 640 in which spectral frames are recorded. The spectral frames may be recorded at any desirable interval, under control of the passive radar module 630. However, the SNOC 150 may instruct the passive radar module 630 with respect to the frequency of generating spectral frames. In some cases, if the secured facility 620 can provide mains power, a high frequency of generation of spectral frames may be possible without concern for power consumption. However, if battery power is required (either due to loss of mains power, or due to lack of mains power availability) managing the frequency of spectral frame generation may be desirable. The SNOC 150 may provide instructions for changing the frame rate based on time of day, weather considerations, or known or planned activity. For example, if it is known that a maintenance visit is to be made between 2:30 and 3:00 μm, the SNOC 150 may reduce the frame rate of the passive radar module 630 accordingly during the corresponding period, or simply turn the passive radar module 630 off. If an event trigger is experienced, the frame rate may also be increased to provide enhanced monitoring until a predetermined (cool down) time has elapsed without any further event triggers. Moreover, if the weather is known to be adverse for passive radar operation (e.g., due to rain or snow), the passive radar module 630 may also be turned off, or have the frame rate increased significantly to save power. In the case of some weather events, such as high winds that may produce excessive movement of trees, bushes or the like, the frame rate may be reduced, and/or the triggering thresholds between frames may be increased. Thus, for example, if high winds are expected, a larger disturbance may be required to cause a trigger event since it will otherwise be expected that tree or bush movement may cause spectral changes between frames that would otherwise cause trigger thresholds to be exceeded.

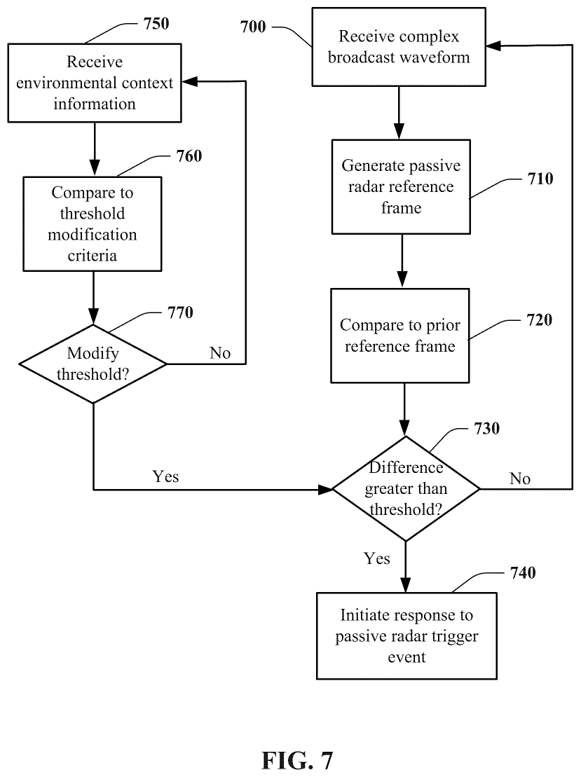

FIG. 7 illustrates a control flow diagram for passive radar employment according to an example embodiment. As shown in FIG. 7, reception of a complex broadcast waveform may occur at operation 700. Thereafter, a passive radar reference frame may be generated at operation 710. The reference frame may then be compared to a prior reference frame at operation 720. If the difference is greater than a threshold amount at operation 730, then a response to a passive radar trigger event may be initiated at operation 740. However, if the difference is less than the threshold at operation 730, then control flow may return back to operation 700 for repeat with respect to subsequently received reference frames.

In some cases, the threshold may be adjustable based on environmental context information (e.g., known maintenance or other visits to the area, known weather conditions, etc.). Thus, for example, environmental context information may be received at operation 750. The environmental context information may be compared to threshold modification criteria at operation 760. If the comparison yields a result that instructs threshold modification at operation 770, then the threshold used at operation 730 may be modified accordingly. However, if the comparison does not yield a result that instructs threshold modification at operation 770, then control flow may loop back to operation 750 to be ready for other receipt of environmental context information.

Example embodiments may in some cases counsel the provision of a cell tower (or any communication tower with IP backhaul) proximate to each power grid sub-station to be sure that backhaul capability is available for monitoring specifically within this context. If provided, the cell tower may further be used for the provision of rural broad band connections for local residents, thereby further enhancing the multi-functional nature of the systems and networks described herein. The cell tower may also be a neutral host providing open access not controlled by any particular private entity or corporation. City, county, state or national resources may be used to provision such towers, and they may serve the public good with respect to the security monitoring functions described herein, the provision of deeply accurate and broadly covered weather information in real time, and the enhancement of first responder or other security functions. Example embodiments therefore effectively provide a blanket of connectivity that is secure, reliable, and most likely extremely low cost since many existing assets will simply be repurposed with software only upgrades.

Thus, in accordance with an example embodiment, an asymmetric communication system may be provided. The system may include a broadcast downlink transmitter configured to transmit a complex broadcast waveform defining a downlink, a user equipment (UE) configured to receive transmission of the downlink from the broadcast downlink transmitter, an uplink base station operably coupled to the UE for uplink transmission from the UE via a different communication protocol than the broadcast downlink transmitter, an IP-based backhaul network operably couple to the uplink base station, and a super network operations center (SNOC) operably coupled to the uplink base station and broadcast downlink transmitter to provide communication services to the UE via the uplink and the downlink. The SNOC may be configured to select the uplink base station from among a plurality of candidate base stations associated with different networks capable of communication with the UE.

In some embodiments, the system may include additional, optional features, and/or the features described above may be modified or augmented. Some examples of modifications, optional features and augmentations are described below. It should be appreciated that the modifications, optional features and augmentations may each be added alone, or they may be added cumulatively in any desirable combination. In an example embodiment, the UE may provide information regarding capabilities of the UE for network communications to enable the SNOC to determine the candidate base stations based on a location of the UE. In an example embodiment, the UE may be required to provide the information regarding capabilities in order to register for services via the system In some cases, the SNOC may be configured to enable handover of the UE from the broadcast downlink transmitter to another broadcast downlink transmitter based on a handover indication from the UE. In an example embodiment, the SNOC may be configured to enable handover of the UE from the uplink base station to another base station that employs a same communication protocol as the uplink base station based on a handover indication from the UE. In some cases, the SNOC may be configured to enable handover of the UE from the uplink base station to another base station that employs a different communication protocol as the uplink base station based on a handover indication from the UE. In an example embodiment, the UE may employ a passive radar module to detect airborne or ground activity proximate to a monitored facility at which the UE is located using passive radar. In some cases, the passive radar module may compare spectral frames generated by a spectrum analyzer at different times for a same monitored region to determine whether a threshold amount of change exists between the compared spectral frames. In an example embodiment, a drone may be launched to perform a surveillance activity based on detecting a trigger condition via the passive radar module. In some cases, the drone may receive command and control instructions regarding air space management via the downlink and communicates sensor, image or video data associated with the surveillance activity via the uplink. In an example embodiment, the UE may be disposed on an aircraft or drone, and wherein instructions for uploading a flight plan of the aircraft or drone are provided via the downlink, and the flight plan is uploaded via the uplink. Authorization to takeoff or launch the aircraft or drone may be withheld until confirmation of receipt of the flight plan is received and registration of the UE with the SNOC is completed. In some cases, the SNOC may evaluate the flight plan relative to an ability to provide continuity of connectivity to the aircraft or drone over an entirety of the flight plan. In an example embodiment, the SNOC may provide recommended changes to the flight plan to maintain continuity of connectivity to the aircraft or drone over the entirety of the flight plan. In some cases, the UE may be located at a monitored facility, and the UE may provide environmental information regarding the monitored facility to the SNOC. In an example embodiment, the SNOC may employ software defined network control to configure candidate base stations to communicate with the UE. In some cases, the UE may employ software defined radio to communicate with different ones of the candidate base stations. In an example embodiment, the SNOC may provide air traffic control signals via the downlink beyond the visual line of sight.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. An asymmetric communication system comprising:
a downlink transmitter configured to transmit a waveform defining a downlink;
a user equipment (UE) configured to receive transmission of the downlink from the downlink transmitter;
an uplink base station operably coupled to the UE for uplink transmission from the UE via a different communication protocol than the downlink transmitter;
an IP-based backhaul network operably couple to the uplink base station; and
a super network operations center (SNOC) operably coupled to the uplink base station and the downlink transmitter to provide communication services to the UE via the uplink and the downlink,
wherein the SNOC is configured to select the uplink base station from among a plurality of candidate base stations associated with different networks capable of communication with the UE.

2. The system of claim 1, wherein the UE provides information regarding capabilities of the UE for network communications to enable the SNOC to determine the candidate base stations based on a location of the UE.

3. The system of claim 2, wherein the UE is required to provide the information regarding capabilities in order to register for services via the system.

4. The system of claim 1, wherein the downlink transmitter is a broadcast downlink transmitter and the waveform comprises a complex broadcast waveform.

5. The system of claim 4, wherein the SNOC is configured to enable handover of the UE from the broadcast downlink transmitter to another broadcast downlink transmitter based on a handover indication from the UE.

6. The system of claim 1, wherein the SNOC is configured to enable handover of the UE from the uplink base station to another base station that employs a same communication protocol as the uplink base station based on a handover indication from the UE.

7. The system of claim 1, wherein the SNOC is configured to enable handover of the UE from the uplink base station to another base station that employs a different communication protocol as the uplink base station based on a handover indication from the UE.

8. The system of claim 1, wherein the UE employs a passive radar module to detect airborne or ground activity proximate to a monitored facility at which the UE is located using passive radar.

9. The system of claim 8, wherein the passive radar module compares spectral frames generated by a spectrum analyzer at different times for a same monitored region to determine whether a threshold amount of change exists between the compared spectral frames.

10. The system of claim 9, wherein a drone is launched to perform a surveillance activity based on detecting a trigger condition via the passive radar module.

11. The system of claim 10, wherein the drone receives command and control instructions regarding air space management via the downlink and communicates image or video data associated with the surveillance activity via the uplink.

12. The system of claim 1, wherein the UE is disposed on an aircraft or drone, and wherein instructions for uploading a flight plan of the aircraft or drone are provided via the downlink, and the flight plan is uploaded via the uplink,
wherein authorization to takeoff or launch the aircraft or drone is withheld until confirmation of receipt of the flight plan is received and registration of the UE with the SNOC is completed.

13. The system of claim 12, wherein the SNOC evaluates the flight plan relative to an ability to provide continuity of connectivity to the aircraft or drone over an entirety of the flight plan.

14. The system of claim 13, wherein the SNOC provides recommended changes to the flight plan to maintain continuity of connectivity to the aircraft or drone over the entirety of the flight plan.

15. The system of claim 1, wherein the UE is located at a monitored facility, and
wherein the UE provides environmental information regarding the monitored facility to the SNOC.

16. The system of claim 1, wherein the SNOC employs software defined network control to configure candidate base stations to communicate with the UE.

17. The system of claim 1, wherein the UE employs software defined radio to communicate with different ones of the candidate base stations.

18. The system of claim 1, wherein the SNOC provides air traffic control signals via the downlink beyond the visual line of sight.

19. A method of conducting a handover of user equipment (UE) in an asymmetrical communication super network; the method comprising:
receiving an indication of a need to handover from the UE;
determining whether the indication corresponds to an uplink handover or a downlink handover;
responsive to determining that the indication corresponds to the downlink handover, executing a downlink handover routine, the downlink handover routine comprising:
determining a target transmit station for establishing a new downlink within communication range of the UE based on UE location, and
providing instructions via a current transmit station to the UE to transition to the new downlink on a selected channel of the target transmit station,
providing instructions to the target transmit station for the UE to confirm via uplink messaging when the new downlink is established, and
receiving confirmation that the UE established the new downlink via the uplink messaging, and
responsive to determining that the indication corresponds to the uplink handover, executing an uplink handover routine, the uplink handover routine comprising:
determining a set of candidate networks with dissimilar communication protocols based on UE capabilities for network communication via each respective one of the dissimilar communication protocols,
determining, from within the set of candidate networks, a target uplink station for establishing a new uplink within reception range of the UE based on the UE location,
providing instructions via the current transmit station for the UE to transition to the new uplink on a selected network of the target uplink station,
providing instructions to the target uplink station to establish communication with the UE via the new uplink, and
receiving confirmation that the UE established the new uplink via the new uplink.

20. The method of claim 19, wherein determining the target transmit station comprises instructing the UE to report signal strength received from a set of candidate transmit stations and selecting the target transmit station as a candidate station among the set of candidate transmit stations for which the UE reports a highest signal strength received.

21. The method of claim 20, wherein the set of candidate transmit stations is determined based on distance from the UE.
